(19) United States
(12) Patent Application Publication
(10) Pub. No.: US 2015/0264274 A1
(43) Pub. Date: Sep. 17, 2015

(54) COMMUNICATION DEVICE AND COMMUNICATION SYSTEM

(71) Applicant: Nobumasa GINGAWA, Kanagawa (JP)

(72) Inventor: Nobumasa GINGAWA, Kanagawa (JP)

(21) Appl. No.: 14/658,837

(22) Filed: Mar. 16, 2015

(30) Foreign Application Priority Data
Mar. 17, 2014 (JP) 2014-052942
Dec. 26, 2014 (JP) 2014-263885

(51) Int. Cl. H04N 5/262; H04N 7/15

(52) U.S. Cl. CPC H04N 5/2628; H04N 7/15

(57) ABSTRACT

A communication device includes a display unit for displaying a display image based on an image that is captured by a capture unit, a retrieval unit for selectively retrieving one correction information item from an information processing device that stores, in advance, a plurality of the correction information items corresponding to rotational errors or tilts of the capture unit, and a correction unit for correcting the display image based on the retrieved correction information item.

### BACKGROUND OF THE INVENTION

1. Field of the Invention

The present invention relates to a communication device and a communication system.

2. Description of the Related Art

A video conference system has been known that is used for conducting, through a communication network, such as the Internet, a conference with a place separated from the place at which the video conference system (which may be also referred to as “TV conference system”) is located. For a camera that may be used for such a video conference system, an installation error may occur when a camera substrate on which a camera sensor (e.g., an image sensor, such as a CMOS or a CCD) is disposed is assembled into a housing. That is because a diameter of a hole in the camera substrate may be greater than that of a mounting screw. When a camera sensor is implemented on a camera substrate or the like, an error on implementation may occur. In addition, depending on a camera installation condition for conducting a video conference, an error may occur in a rotational direction from the horizontal position. A technique has already been known for correcting such a rotational error around an optical axis of a camera.

For example, the following technique for executing a correction process has been known (cf. Patent Document 1 (Japanese Unexamined Patent Publication No. 2009-17169), for example). That is, a deviation θ in a rotational direction around an optical axis of an installation position of a camera is detected, and a rotation correction map that is closest to the deviation θ is selected from a plurality of rotation correction maps. Then, the correction process is executed based on the selected rotation correction map.

### SUMMARY OF THE INVENTION

In a communication system, such as the video conference system, when an image that is transmitted from a communication destination includes a rotational error or the image is tilted, according to the technique that is disclosed in Patent Document 1, it may be necessary to ask a participant or the like in the communication destination side for correction of the rotational error or a tilt of the camera that is for capturing an image. However, a participant in each site who conducts the video conference may not be able to perform error correction of the camera. Accordingly, in a communication system for communicating an image that is captured by a camera, when a position of the camera includes a rotational error or the camera is tilted, it may be difficult to correct an image that is captured by the camera.

There is a need for facilitating correction of an image that is captured by a camera when a position of the camera includes a rotational error or the camera is tilted.

According to an aspect of the present invention, there is provided a communication device including a display unit configured to display a display image based on an image that is captured by an image capture unit; a retrieval unit configured to selectively retrieve one correction information item from an information processing device configured to store a plurality of the correction information items, each of the correction information items corresponding to a rotational error or a tilt of the image capture unit; and a correction unit configured to correct the display image based on the retrieved correction information item.

According to another aspect of the present invention, there is provided a communication system including a capture unit configured to capture an image; a display unit configured to display a display image based on the captured image; a storage unit configured to store, in advance, a plurality of correction information items corresponding to rotational errors or tilts of the capture unit; and a correction unit configured to correct the display image based on the plurality of correction information items that is stored.

According to the embodiment of the present invention, in a communication system for communicating an image that is captured by a camera, even if a position of the camera includes a rotational error or the camera is tilted, an image that is captured by the camera can be easily corrected.

Other objects, features and advantages of the present invention will become more apparent from the following detailed description when read in conjunction with the accompanying drawings.

### BRIEF DESCRIPTION OF THE DRAWINGS

FIG. 1 is a configuration diagram of a video conference system according to an embodiment;

FIG. 2 is a hardware configuration diagram of a video conference device according to the embodiment;

FIG. 3 is a functional configuration diagram of the video conference system according to the embodiment;

FIG. 4 is a flowchart showing a processing flow of the video conference device according to an embodiment;

FIGS. 5A and 5B are diagrams illustrating an error or a tilt in a rotational direction according to the embodiment;

FIG. 6A is a diagram showing an example of an adjustment screen according to the embodiment;

FIG. 6B is a diagram showing an example of an adjustment operation unit according to the embodiment;

FIG. 7 is a flowchart showing a processing flow of a video conference system according to another embodiment;

FIG. 8 is a diagram showing an example of a hardware configuration of a server device according to another embodiment;

FIG. 9 is a functional configuration diagram of a video conference system according to the embodiment;

FIG. 10 is a flowchart showing a flow of a correction process of the video conference system according to the embodiment;

FIG. 11 is flowchart showing a flow of a correction process of the server device according to the embodiment; and

FIG. 12 is a sequence chart showing an example of the correction process according to the embodiment.

### DETAILED DESCRIPTION OF THE PREFERRED EMBODIMENTS

The embodiment of the present invention is explained by referring to the accompanying drawings below.

<System Configuration>

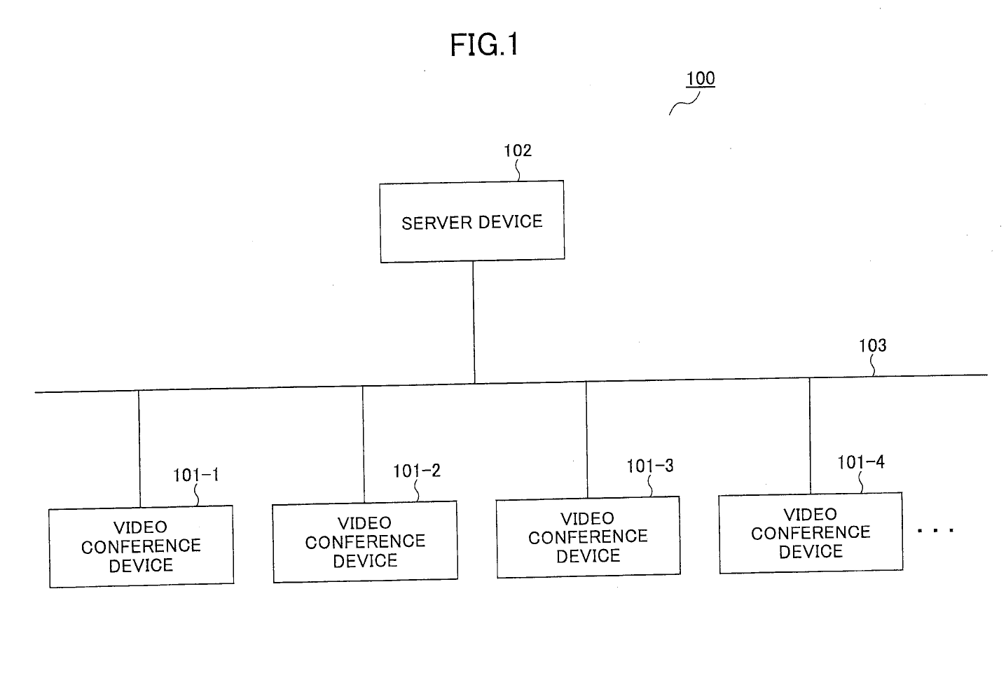

FIG. 1 is a configuration diagram of a video conference system according to the embodiment. The video conference system 100 includes a plurality of video conference devices 101-1 to 101-4 (in the embodiment, which may be referred to as “communication devices” below) that are connected to a network 103, such as the Internet, and a server device 102 (in the embodiment, which may be referred to as “information processing device” below), for example. The video conference system 100 is an example of a communication system. The communication system may be another communication system that includes a capture unit (e.g., a camera), such as a monitoring camera system, an image delivery system, and so forth. Namely, as described above, a communication device can be a device for receiving an image from a capture unit, such as a camera or the like that is used for a video conference system, a monitoring camera system, an image delivery system, and so forth.

In the description below, for indicating some video conference devices among the plurality of video conference devices 101-1 to 101-4, the notation “video conference device 101” may be used.

The video conference device 101 is a terminal device that supports the video conference system 100. The video conference device 101 may be a general-purpose information processing device, such as a personal computer (PC), a tablet terminal, a smart phone, and so forth. When the video conference device 101 is a general-purpose information processing device, each function of the video conference device 101 may be implemented by an application program that is installed in the information processing device, for example. Here, the terminal device is an example of the communication device. Namely, in the video conference system 100, the video conference devices 101-1 to 101-4 are configured such that they can communicate (transmit and receive) images with each other.

The server device 102 is for controlling a video conference. The server device 102 may monitor a connected state, such as whether each of the video conference devices 101-1 to 101-4 is connected to the video conference system 101. The server device 102 may execute connection control at a start or end of a video conference. The server device 102 may communicate data, such as image data (video) or audio data, for example. The server device 101 may include a codec function for encoding data that is obtained from the video conference device 101 and for decoding encoded data that is obtained from the video conference device 101.

By the above-described configuration, for example, a user of the video conference device 101-1 may conduct a video conference with users of the other video conference devices 101-2 to 101-4 through image data and audio data that are communicated in real time.

Here, the configuration shown in FIG. 1 is for exemplifying purposes only. The number of the video conference devices 101 that are included in the video conference system 100 may be any number that is greater than or equal to 2, for example. The server device 102 may be a device that includes a plurality of servers.

<Hardware Configuration>

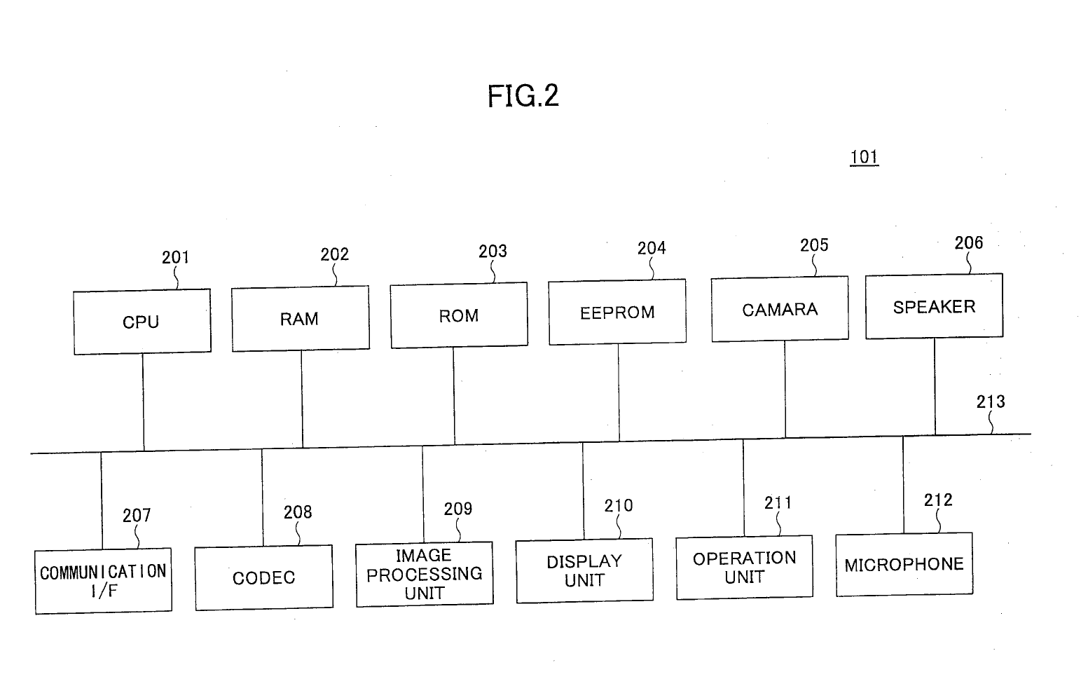

FIG. 2 is a hardware configuration diagram of the video conference device 101 according to an embodiment. The video conference device 101 includes a configuration of a generic computer. For example, the video conference device 101 includes a central processing unit (CPU) 201, a random access memory (RAM) 202, a read-only memory (ROM) 203, an electrically erasable programmable read-only memory (EEPROM) 204, a camera 205, a speaker 206, a communication interface (I/F) 207, a codec 208, an image processing unit 209, a display unit 210, an operation unit 211, a microphone 212, a bus 213, and so forth. The video conference device 101 is an example of a communication device.

The CPU 201 is a processor for implementing various functions that are included in the video conference device 101. The various functions of the video conference device 101 can be implemented by the CPU by reading a program and/or data in the ROM 203 or the like and executing some processes. The RAM 202 is a volatile memory that can be used as a work area or the like of the CPU 201. The ROM 203 is a non-volatile memory for storing a program and/or data, for example. The EEPROM 204 is a non-volatile memory for storing, for example, setting values and/or correction information of the video conference system 101.

The camera 205 is a capture unit for capturing, in accordance with a command of the CPU 201 or the like, an image of a participant of a video conference, for example. The camera 205 includes an image sensor, such as a complementary metal oxide semiconductor (CMOS) or a charge coupled device (CCD).

The speaker 206 may convert an audio signal that is received from the video conference device 101 that is the communication destination into sound, and may output the sound. The microphone 212 may receive voice sound of a participant of a video conference, and may convert the voice sound into an audio signal.

The communication I/F 207 is for connecting the video conference device 101 to the network 103. The communication I/F 207 is an interface for communicating data with another video conference device 101 or the server device 102.

The codec 208 is for encoding an image or a voice that is to be transmitted to the video conference device 101 that is the communication destination through the server device 102. Additionally, the codec 208 is for decoding data or an image that is received from the video conference device 101 that is the communication destination into data.

The image processing unit 209 is for applying, in accordance with a command from the CPU, for example, image processing to a conference image to be communicated.

The display unit 210 is for displaying, for example, an image that is received from the video conference device 101 that is the communication destination. The display unit may be a display device, such as a liquid crystal display or a projector.

The operation unit 211 is a unit of the video conference device 101 for receiving an operation by a user. The operation unit 211 may be an operation button, or a keyboard, for example. The bus 213 may include an address bus and/or a data bus. The bus 213 is for communicating various control signals, for example.

The above-described configuration is for exemplifying purposes only, and it is not intended to limit the present invention. For example, the ROM 203 and the EEPROM 204 may be a single flash ROM or the like. Additionally, the video conference device 101 may further include a storage device, such as a hard disk drive (HDD) and a solid state drive (SSD).

The codec 208 may be included in the server device 102 as described in the explanation of FIG. 1, or the codec 208 may be implemented by a program that is executed by the CPU 201. The image processing unit 209 may be implemented by a program that is executed by the CPU 201.

<Functional Configuration>

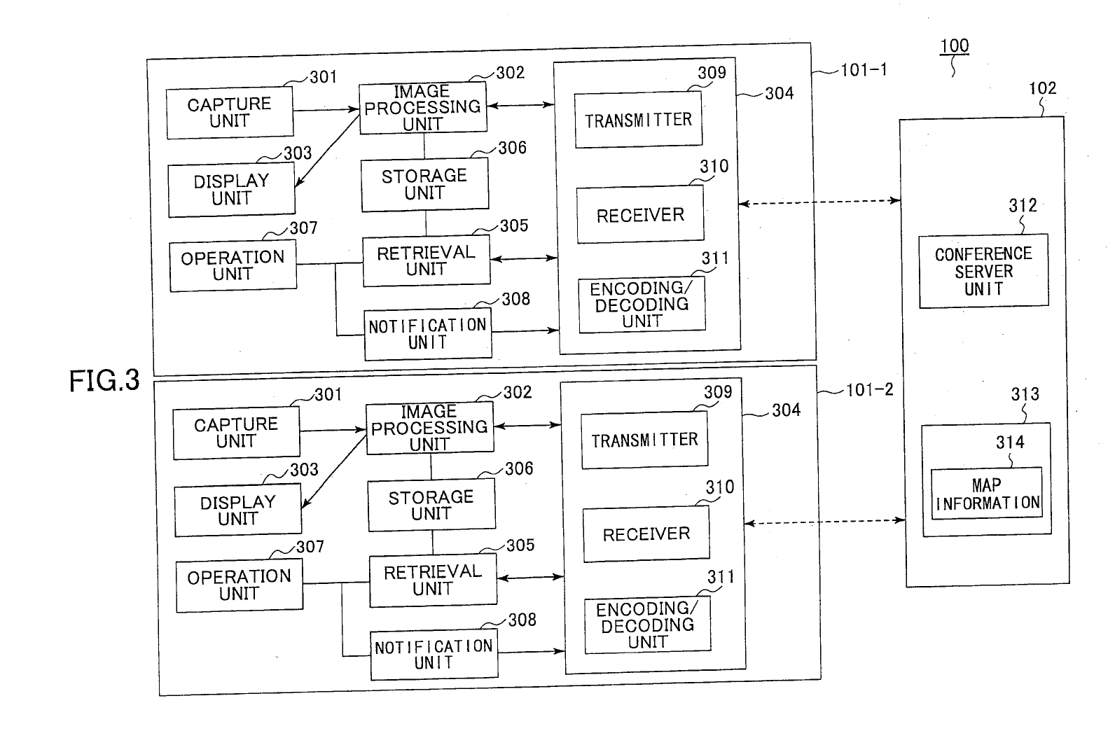

FIG. 3 is a functional configuration diagram of the video conference system according to an embodiment.

(Functional Configuration of the Video Conference Device)

As shown in FIG. 3, the video conference device 101 may include a capture unit 301, an image processing unit 302, a display unit 303, a communication unit 304, a retrieval unit 305, a storage unit 306, an operation unit 307, a notification unit 308, and so forth.

The capture unit 301 is a unit for capturing an image of a conference, such as an image of a participant of the conference, an image of a whiteboard, or an image projected by a projector. The capture unit 301 may include the camera 205 of FIG. 2, for example.

The image processing unit (a correction unit) 302 is for correcting an image of a conference that is captured by the capture unit 301 or a capture unit 301 of the video conference device 101 that is the communication destination, based on correction information that is retrieved by the retrieval unit 305 from the server device 102, for example. The image processing unit 302 may execute a correction process (a rotation process) for correcting a rotational error of a conference image by using a rotation correction map (correction information) that is retrieved from the server device 102 by the retrieval unit 305 and stored in the EEPROM 204, for example. Further, the image processing unit 302 may execute cutting of an image, and scaler processing (a resolution conversion process) so as to adjust a shift of an image that is caused by a rotation process. The image processing unit 302 may include the image processing unit 209 of FIG. 2, for example. Alternatively, the image processing unit 302 may be implemented by a program that is executed by the CPU 201.

The display unit 303 is a unit for displaying a display image based on an image that is captured by the capture unit 301 or a capture unit 301 of the video conference device 101 that is the communication destination, for example. The display unit may include the display unit 210 of FIG. 2, for example.

The communication unit 304 is a unit for connecting the video conference device 101 to the network 103, and for communicating data with the server device 102 or another video conference device 101. The communication unit 304 may include a transmitter 309, a receiver 310, and an encoding/decoding unit 311, for example.

The transmitter 309 is for transmitting data, such as an image of a conference or a sound signal, or various types of information to the server device 102 or another video conference device 101 through the network 103. The receiver 310 is for receiving data, such as an image of a conference or a sound signal, or various types of information from the server device 102 or another video conference device 101 through the network 103. The transmitter 309 and the receiver 310 may correspond to the communication I/F 207 of FIG. 2, for example.

The encoding/decoding unit 311 is for encoding an image of a conference or a sound signal that is transmitted by the transmitter 309 by using a video encoding technique, such as H.264 Scalable Video Coding (SVC), or H.264 Advanced Video Coding (AVC). In addition, the encoding/decoding unit 311 may decode data that is encoded by using, for example, H.264 SVC and that is received by the receiver 310, and output an image or a sound signal to a communication destination. The encoding/decoding unit 311 may correspond to the codec 208 of FIG. 2, for example. The encoding/decoding unit 311 may be separately provided from the communication unit 304. The encoding/decoding unit 311 may be implemented by a program that is executed by the CPU 201.

The retrieval unit 305 is for selectively retrieving one rotation correction map from a plurality of rotation correction maps (correction information) corresponding to rotational errors or inclinations of a capture unit (for example, the capture unit 301 or a capture unit 301 of a video conference device 101 of a communication destination) that are stored in the server device 102 in advance. The retrieval unit 305 may retrieve a rotation correction map that is used for correction from the server device 102 based on a rotational error of a display image or angular information θ that indicates an inclination of the display image that is displayed by the display unit 303, and resolution information of the display unit 303, for example. Alternatively, the retrieval unit 305 may retrieve a rotation correction map that is used for correction based on the resolution information of the display unit 303 and angular information θ that is reported from another video conference device 101. The retrieval unit 305 may be implemented by a program that is executed by the CPU 201, for example.

The storage unit 306 is a unit for storing a rotation correction map that is retrieved by the retrieval unit 305 from the server device 102. For example, the storage unit 306 may include a non-volatile storage area of the EEPROM 204 of FIG. 2, and a temporary storage area of the RAM 202 of FIG. 2.

The operation unit 307 is a unit for receiving an input operation by a user. The operation unit 307 may include the operation unit 211 of FIG. 2, for example.

The notification unit 308 is a unit for reporting a rotational error of a display image or angular information θ that indicates an inclination of the display image that is displayed by the display unit 303 to another video conference device 101. For example, the notification unit 308 may be implemented by a program that is executed by the CPU 201.

(Functional Configuration of the Server Device)

As shown in FIG. 3, the server device 102 may include a conference server unit 312, and a storage unit 313. The conference server unit 312 is for monitoring a connection state of the video conference device 101, for executing connection control of the video conference device 101, and for executing control of a video conference, such as communication of data (e.g., an image or an audio signal). The conference server unit 312 may be implemented by a program that is executed by the server device 102, for example.

The storage unit 313 of the server device 102 is for storing map information 314, such as a plurality of rotation correction maps that correspond to rotational errors or inclinations of the capture unit 301. The storage unit 313 may be implemented in a storage device of the server device 102, such as a hard disk drive (HDD) or a solid state drive (SSD).

The above-described configuration is for exemplifying purpose only, and it is not intended to limit the scope of the present invention. For example, the encoding/decoding unit 311 and the image processing unit 302 may be included in the server device 102. Further, the video conference system 100 may include a plurality of server devices, and a server device that includes the conference server unit 312 may be different from a server device that includes the storage unit 313.

<Processing Flow>

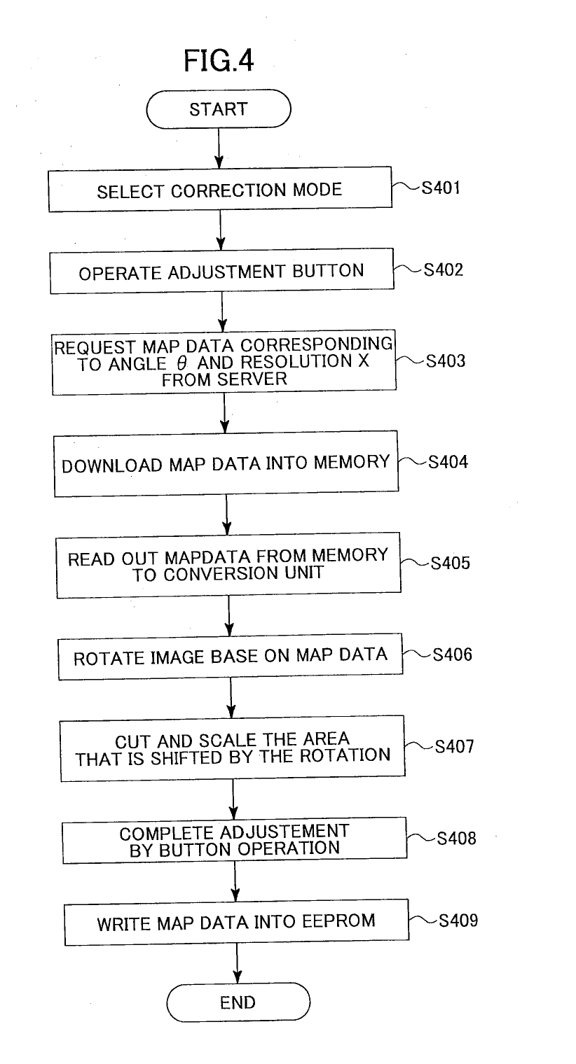

FIG. 4 is a flowchart showing a processing flow by the video conference device 101 according to an embodiment. The process shown in FIG. 4 is an example of a process of correcting (adjusting) a rotational error or an inclination of a conference it is assumed that a position of the capture unit 301 includes a rotational error, or the capture unit 301 is tilted.

For example, when an adjustment mode is selected (step S401) by an operation on the operation unit 307 by a user of the video conference device 101, an operation mode of the video conference device 101 transitions to the adjustment mode. Then, the video conference device 101 may display an adjustment screen on the display unit 303, for example. The user may adjust the display screen by operating an adjustment button of the operation unit 307 based on the adjustment screen (S402).

An example of adjustment of the display screen is explained below.

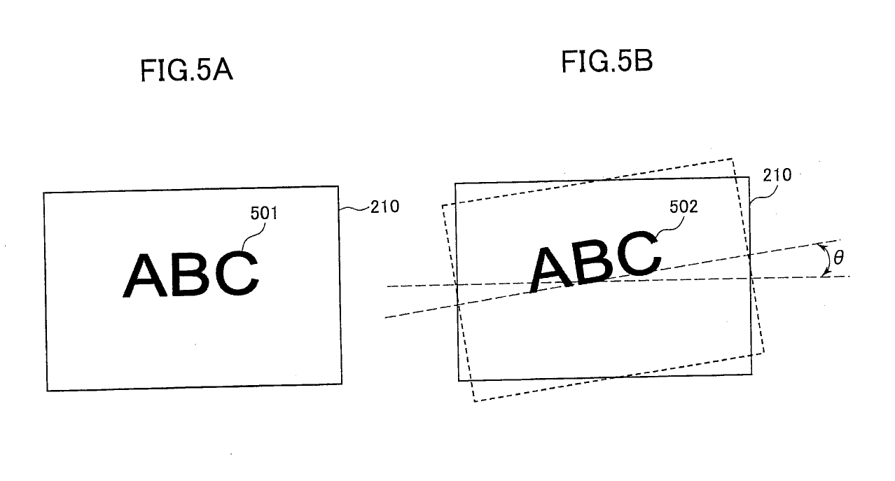

FIGS. 5A and 5B are diagrams illustrating an error or a tilt in a rotational direction of the display screen according to the embodiment. FIG. 5A shows an example of the display screen for a case in which a position of the capturing unit 301 does not include a rotational error around an optical axis direction (an error in the rotational direction), or the capturing unit 301 is not tilted. In FIG. 5A, it is assumed that the display image 501 is displayed on the display unit 210 in a state without the rotational error or the tilt.

FIG. 5B shows an example of the display screen for a case in which the position of the capturing unit 301 includes a rotational error around the optical axis direction, or the capturing unit 301 is tilted. In FIG. 5B, the display image 502 is displayed on the display unit 210 in a state in which the display image 502 is tilted relative to the display image 501 of FIG. 5A. In the embodiment, the rotational error or the tilt of a conference screen (the display screen and/or a transmission screen) is corrected by obtaining angular information θ that shows the tilt in the adjustment screen, and retrieving a rotation correction map for a correction angle that is close to the obtained angular information θ from the server device 102. The rotational error or the tilt of the display screen may include an assembly error that occurs for assembling the camera substrate into the housing of the video conference device 101, an implementation error for implementing a camera sensor on the camera substrate, or a tilt for disposing the camera, for example.

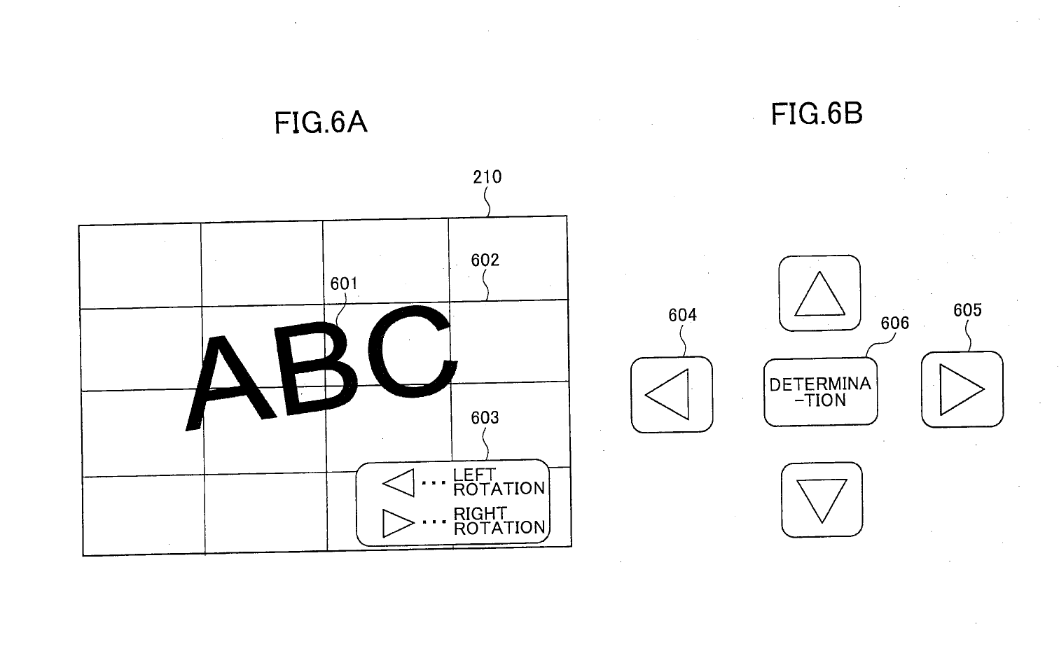

FIG. 6A is a diagram showing an example of the adjustment screen according to the embodiment, and FIG. 6B is a diagram showing an example of an adjustment operation unit according to the embodiment. FIG. 6A shows an example of the adjustment screen. In FIG. 6A, grid lines 602 and an operation guide 603 are displayed together with the display image 601 on the display unit 210 (the display unit 303). The grid lines 602 are evenly spaced in the vertical direction and the horizontal direction in the display unit 210. The operation guide 603 shows an operation method.

FIG. 6B shows an example of the adjustment operation unit. In FIGS. 6A and 6B, when a left direction button 604 is pressed in accordance with the operation guide 603, the display image 601 is displayed in a state in which the display image 601 is rotated in the left direction by a predetermined angle (e.g., 1 degree) around the center of the display screen of the display unit 210. Similarly, by pressing the right direction button 605, the display image 601 is displayed in a state in which the display image is rotated in the right direction by a predetermined angle around the center of the display screen of the display unit 210. The user may correct the tilt of the display image 601 by operating the left direction button 604 and/or the right direction button 605, for example. When the correction is completed, the user may press a determination button 606.

The video conference device 101 may use this rotation angle of the display image 601 that is made by the user at this time as the angular information θ. The display image 601 of “ABC” in FIG. 6A is for exemplifying purposes only. The adjustment of the display image can be more easily performed by capturing, by the capturing unit 301 that is to be adjusted, an image that is more suitable for the adjustment, such as an image of a desk, an image of a pillar, or an image of a window.

Returning to FIG. 4, the explanation of the flowchart is continued. At step S402, when the angular information θ is obtained by the operation of the adjustment button or the like, the retrieval unit 305 requests map data (a rotation correction map) from the server device 102 by using the angular information and the resolution information X of the display unit 303 (step S403). The map data is correction information for correcting a rotational error or a tilt. Further, the retrieval unit 305 may download the map data from the server device 102 into a memory (the storage unit 306) (step S404).

Subsequently, the image processing unit 302 (an image conversion unit) may read out the map data from the memory (step S405), and the image processing unit 302 may execute a rotation process of the display image (step S406). Further, the image processing unit 302 may cut out an area that is shifted by the rotation process, and the image processing unit 302 may execute scaler processing (step S407). For example, as shown in FIG. 5B, when the display image 502 is rotated in the right direction so that the angle θ becomes zero, the four corners may be missed. Thus, the image processing unit 302 may modify (create) the display image by enlarging the display image (the scaler processing), and by cutting out the image so that the modified display image matches the display unit 210.

The user may confirm an image that is displayed on the display unit 303 as a result of the above-described processing. When the image is successful, the user may complete the adjustment by a button operation or the like (step S408). When the adjustment is completed, the image processing unit 302 may correct the display image by using the map data that is stored in the storage unit 306. By doing this, the display image without tilt can be displayed on the display unit 303.

When a capture unit 301 that is to be corrected is the capture unit 301 of the video conference device 101 itself, a correction process that is similar to the process that is applied to the display image may be applied to an image that is to be transmitted to another video conference device 101. By doing this, an image without a rotational error or a tilt can be transmitted to another video conference device 101.

Additionally, when the adjustment is completed at step S408, the video conference device 101 may write the map data into a non-volatile area (e.g., the EEPROM 204) of the storage unit 306 (step S409). By doing this, when the power-supply is turned on the next time, the adjusted map information may be automatically read out from the storage unit 306, and a correction process for correcting an image may be executed.

By the above-described process, correction of a rotational error or a tilt of the capture unit 301 can be easily performed. Here, the capture unit 301 that is to be corrected may be the capturing unit 301 that is built in or connected to (i.e., an external capturing unit) the video conference device 101 itself, or may be a capturing unit that is built in or connected to a communication destination device that is a communication destination of the video conference device 101. The communication destination device may be another video conference device 101, or may be a device other than a video conference device 101, such as a monitoring camera.

As described above, according to the embodiment, for a communication system, such as a video conference system, a video conference device 101 (a communication device) can be provided that facilitates correction of an image that is captured by a camera whose position includes a rotational error or which is tilted.

The video conference device 101 according to the embodiment can utilize the map data that is stored in the server device 102 as the map data for error adjustment around the optical axis of the camera. Thus, the error adjustment around the optical axis can be performed without increasing the memory capacity of the video conference device 101.

The above-described processing is for exemplifying purposes only, and it is not intended to limit the scope of the present invention. It is explained that, in step S402, the angular information θ is obtained by the button operation by the user. However, the angular information θ may be calculated by image processing by the image processing unit 302, for example.

Another embodiment is explained below. In this embodiment, an example is explained in which the video conference device 101-1 may cooperate with the video conference device 101-2 that is the communication destination to correct a rotational error or a tilt of the capture unit 301.

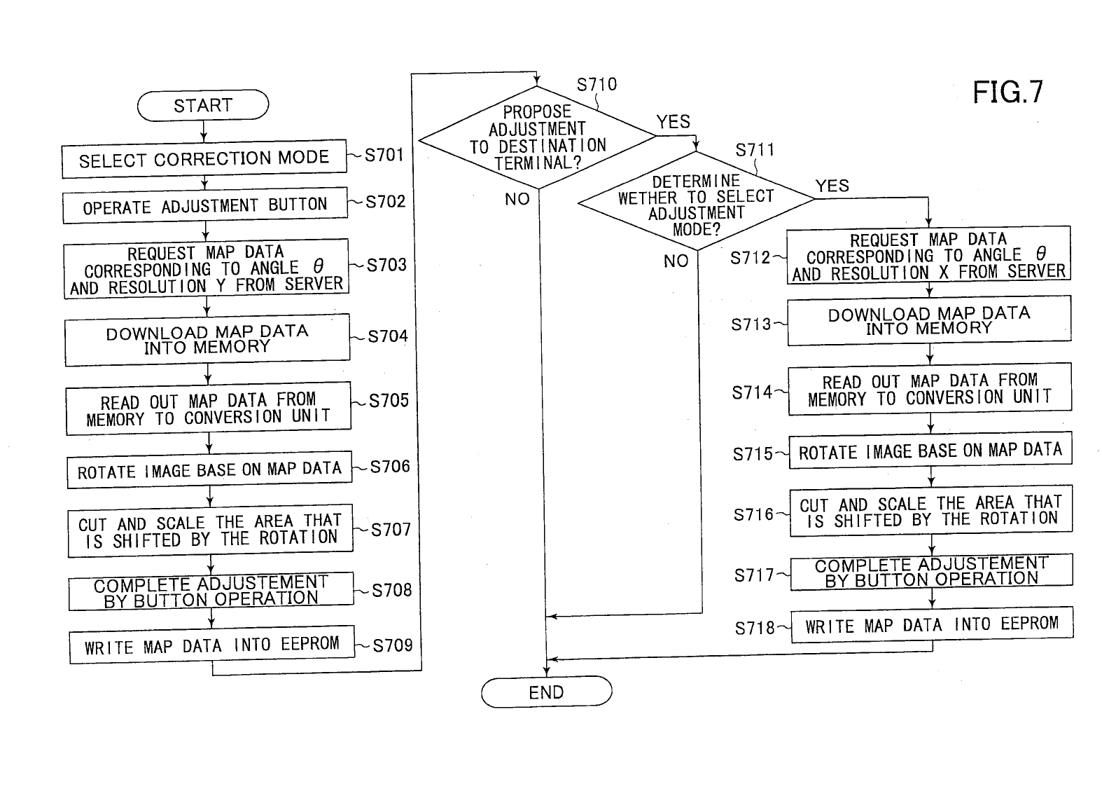

FIG. 7 is a flowchart showing a processing flow of the video conference system according to the embodiment. For example, when an adjustment mode of the video conference device 101-1 is selected by an operation on the operation unit 307 by the user of the video conference device 101-1 (step S701), an operation mode of the video conference device 101-1 may transition to the adjustment mode, and the video conference device 101-1 may display an adjustment screen on the display unit 303. The user may adjust the display screen by operating the adjustment button of the operation unit 307 based on the adjustment screen (S702). By doing this, the angular information θ is obtained as explained in the previous embodiment.

After the angular information θ is obtained, the retrieval unit 305 of the video conference device 101-1 may request map data (a rotation correction map) from the server device 102 by using the angular information θ and the resolution information X of the display unit 303 (step S703). Here, the map data is correction information for correcting the rotational error or the tilt. Further, the retrieval unit 305 may download the map data from the server device 102 into the memory (the storage unit 306) (step S704).

Subsequently, the image processing unit 302 (the image conversion unit) of the video conference device 101-2 may read out the map data from the memory (step S705), and the image processing unit 302 may execute a rotation process for rotating the display image based on the map data (step S706). Additionally, the image processing unit 302 may cut out the area that is shifted by the rotation process, and the image processing unit 302 may execute the scaler processing (step S707).

The user may confirm the image that is displayed on the display unit 303 as the result of the above-described process. When the image is successful, the user may complete the adjustment, for example, by a button operation (step S708). After completion of the adjustment, the notification unit 308 of the video conference device 101-1 may transmit (report) the angular information θ to the video conference device 101-2 that is the communication destination (step S709).

For example, at step S710, the video conference device 101-1 may select whether to propose adjustment to the video conference device 101-2 that is the communication destination.

When the video conference device 101-2 receives the angular information θ from the video conference device 101-1 and receives the proposal of the adjustment (YES in step S710), the video conference device 101-2 may determine whether to select the adjustment mode (step S711). The determination as to whether or not to select the adjustment mode may be made based on setting values that are stored in the video conference device 101-2 in advance. Alternatively, for the determination as to whether or not to select the adjustment mode, the user may be prompted for the selection.

At step S711, when a determination is made to select the adjustment mode (YES in step S711), the video conference device 101-2 may request the map data from the server 102 by using the received angular information θ and the resolution information X of the display unit 303 of the video conference device 101-2 (step S712). Further, the video conference device 101-2 may download the map data from the server device 102 into the memory (the storage unit 306) (step S713).

Subsequently, the image processing unit 302 (the image conversion unit) of the video conference device 101-2 may read out the map data from the memory (step S714), and the image processing unit 302 may execute a rotation process for rotating the display image based on the map data (step S715). Additionally, the image processing unit 302 may cut the area that is shifted by the rotation process, and the image processing unit 302 may execute the scaler processing (step S716).

The user may confirm the image that is displayed on the display unit 303 as the result of the above-described process. When the image is successful, the user may complete the adjustment by a button operation (step S717). When the adjustment is completed, the image processing unit 302 may correct the display image by using the map data that is stored in the storage unit 306. By doing this, the display data without the tilt can be displayed on the display unit 303.

Further, when the capture unit 301 that is to be adjusted is the capture unit 301 of the video conference device 101-2, a correction process that is similar to the correction process for the display image may be applied to an image that is to be transmitted to another video conference device 101, such as the video conference device 101-1. By doing this, an image data without a rotational error or a tilt can be transmitted to another video conference device 101, such as the video conference device 101-1.

Further, when the adjustment is completed at step S717, the video conference device 101-2 may write the map data in the non-volatile area (e.g., the EEPROM 204) of the storage unit 306 (step S718). By doing this, when the power-supply is turned on for the next time, the adjusted map information may be automatically read out from the storage unit 306, and a correction process for correcting an image may be executed.

According to this embodiment, the video conference device 101-2 can correct a rotational error or a tilt of a display image and/or an image that is to be transmitted, based on the angular information θ that is retrieved, for example, from the video conference device 101-1 that is the communication destination. Thus, adjustment of a rotational error or a tilt of a camera can be executed from any site, even if the camera is disposed in a site where there is no participant who can perform the adjustment of the camera.

Hereinafter, another embodiment is explained. In this embodiment, an example is explained in which the server device 102 includes an image processing unit (a correction unit) for correcting a rotational error of a conference image. Here, basic configurations and processes are the same as those of the previous embodiments. Accordingly, in the embodiment, differences are mainly explained.

<Hardware Configuration>

(Hardware Configuration of the Server Device)

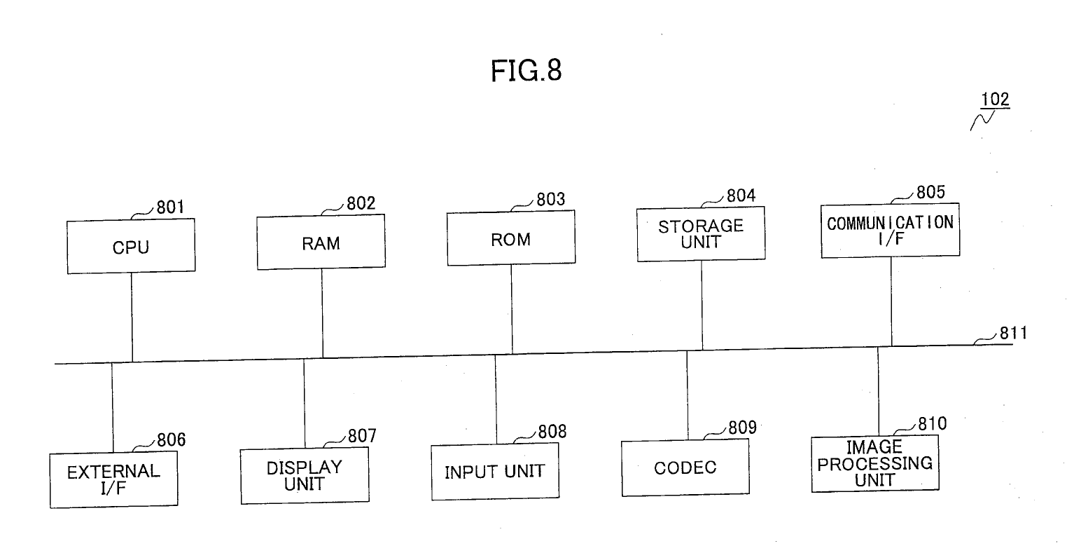

FIG. 8 is a diagram showing an example of a hardware configuration of the server device according to this embodiment. The server device 102 may include a configuration of a generic computer. For example, the server device 102 may include a CPU 801, a RAM 802, a ROM 803, a storage unit 804, a communication I/F 805, an external I/F 806, a display unit 807, an input unit 808, a codec 809, an image processing unit 810, a bus 811, and so forth.

The CPU 801 is a processor for implementing various functions of the server device 102. The various functions of the server device 102 can be implemented by the CPU 801 by executing some processes by reading out a program and/or data from the ROM 803 and/or the storage unit 804 and writing the program and/or the data onto the RAM 802. The RAM 802 is a volatile memory that may be used as a work area of the CPU 801. The ROM 803 is a non-volatile memory for storing, for example, a Basic Input/Output System (BIOS) that is to be executed during activation of the server device 102, or various settings. The ROM 803 may include a flash ROM, for example.

The storage unit 804 may be a non-volatile storage device for storing, for example, an operating system (OS), an application program, and/or various types of data. The storage unit 804 may include a HDD and/or a SSD, for example.

The communication I/F 805 is a communication interface for connecting the server device 102 to the network 103, and for executing data communication with the plurality of video conference devices 101-1 to 101-4, for example.

The external I/F 806 is an interface for connecting an external device. Examples of the external device include a recording medium, such as a universal serial bus (USB) memory, a memory card, or an optical disk, and various types of electronic devices.

The display unit 807 may be a display device, such as an LCD display, for displaying a processing result by the server device 102, for example. The input unit 808 may be an input device, such as a keyboard, a mouse, or a touch panel, for receiving a user operation at the server device 102. The display unit 807 and the input unit 808 may be a display/input unit, such as a touch panel display, such that a display device and an input device are integrated.

The codec 809 may be a hardware component, such as a codec large scale integration (LSI) or a DSP, for encoding and decoding image data and/or audio data by a video encoding technique, such as H. 264 SVC or H.264 AVC.

The image processing unit 810 may be a hardware component, such as an image processor or a DSP, for executing or assisting image processing in accordance with control of the CPU 801.

The bus 811 may be connected to each of the above-described components. The bus 811 may communicate an address signal, a data signal, and various control signals.

The above-described configuration of the server device 102 is for exemplifying purposes only. For example, in the server device 102, the codec 809 or the image processing unit 810 may be implemented by software.

<Functional Configuration>

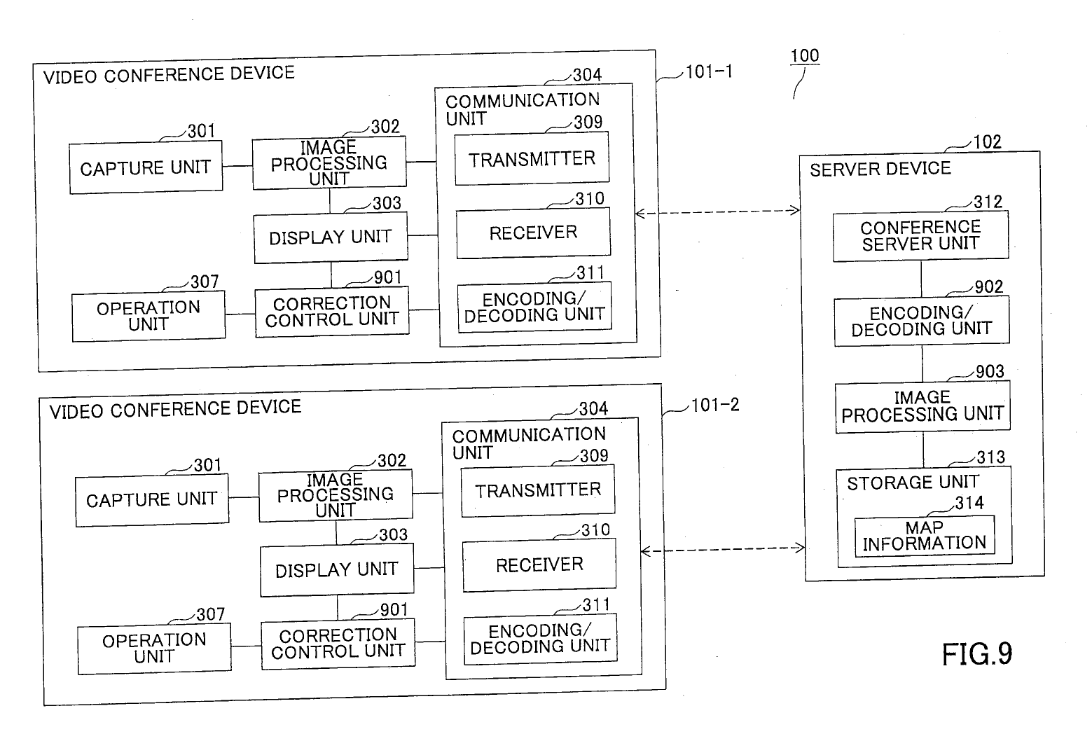

FIG. 9 is a functional configuration diagram of the video conference system according to the embodiment. In the example of FIG. 9, the video conference system 100 may include the server device 102, and the video conference devices 101-1 and 101-2 that are capable of communicating with the server device 102. The video conference system 100 is an example of a communication system. For example, the communication system may be a system other than a video conference system including a capture unit, such as a monitoring camera system, an image delivery system, or a camera.

(Functional Configuration of the Video Conference System)

The video conference device 101 according to the embodiment may include the capture unit 301, the image processing unit 302, the display unit 303, the communication unit 304, the operation unit 307, a correction control unit 901, and so forth.

The capture unit 301 is a unit for capturing an image of a conference (e.g., video), such as an image of a participant of the conference, an image of a whiteboard, or an image projected by a projector. The capture unit 301 may be implemented by the camera 205 of FIG. 2 or a program that is executed by the CPU 201, for example.

The image processing unit 302 is for applying image processing to an image that is captured by the capture unit 301 or to an image that is displayed by the display unit 303, and for outputting the image to which the image processing is applied. Examples of the image processing include white balance, exposure compensation, edge enhancement, noise reduction, gamma correction, and so forth. In this embodiment, it is assumed that the correction process for correcting the rotational error of the conference image is executed by the image processing unit 903 of the server device 102, instead of the image processing unit 302 of the video conference device 101. The image processing unit 302 may be implemented by the image processing unit 209 of FIG. 2 and a program that is executed by the CPU 201.

The display unit 303 is a unit for displaying a display image based on an image that is captured by the capture unit 301 or a capture unit 301 of the video conference device 101 that is the communication destination, for example. The display unit may be implemented by the display unit 210 of FIG. 2 and a program that is executed by the CPU 201.

The communication unit 304 is a unit for connecting the video conference device 101 to the network 103, and for communicating with the server device 102. The communication unit 304 may include the transmitter 309, the receiver 310, and the encoding/decoding unit 311, for example.

The transmitter 309 is for transmitting data, such as an image of a conference or a sound signal, or various types of information to the server device 102 or the like through the network 103. The receiver 310 is for receiving data, such as an image of a conference or a sound signal, or various types of information from the server device 102 or the like through the network 103. The transmitter 309 and the receiver 310 may be implemented by the communication I/F 207 of FIG. 2, for example.

The encoding/decoding unit 311 is for encoding an image of a conference or a sound signal that is transmitted by the transmitter 309 by using a video encoding technique, such as H.264 SVC or H.264 AVC. In addition, the encoding/decoding unit 311 may decode data that is encoded by using, for example, H.264 SVC and/or H.264 AVC and that is received by the receiver 310, and output an image or a sound signal to a communication destination. The encoding/decoding unit 311 may be implemented by the codec 208 of FIG. 2, for example. The encoding/decoding unit 311 may be separately provided from the communication unit 304. The encoding/decoding unit 311 may be implemented by a program that is executed by the CPU 201.

The operation unit 307 is a unit for receiving an input operation by a user. The operation unit 307 may be implemented by the operation unit 211 of FIG. 2 and a program that is executed by the CPU 201, for example.

The correction control unit 901 is for receiving an adjustment operation for adjusting a rotational error of a conference image through the operation unit 307. In addition, the correction control unit 901 is for transmitting request information for requesting a rotation process from the server device 102, based on the received adjustment operation. For example, the correction control unit 901 may cause the display unit 303 for displaying a conference image to display the grid lines 602 and the operation guide 603, such as shown in FIG. 6A. Then, the correction control unit 901 may receive an adjustment operation by a user that is input to the adjustment operation unit, such as shown in FIG. 6B. In the example of FIGS. 6A and 6B, when a user presses the right direction button 605 once in accordance with the operation guide 603, the correction control unit 901 may transmit request information for requesting rotation of the conference image by a predetermined angle (e.g., 1 degree) in the right direction to the server device 102. Similarly, when a user presses the left direction button 604 once, the correction control unit 901 may transmit request information for requesting rotation of the conference image by a predetermined angle (e.g., 1 degree) in the left direction to the server device 102. The correction control unit 901 may be implemented by a program that is executed by the CPU 201 of FIG. 2, for example.

With the above-described configuration, when a conference image from the video conference device 101-2 is tilted, for example, the video conference device 101-1 may transmit request information for requesting rotation of the conference image to the server device 102 in accordance with an operation on the operation unit 307.

(Functional Configuration of the Server Device)

The server device 102 according to the embodiment may include the conference server unit 312, an encoding/decoding unit 902, the image processing unit 903, the storage unit 313, and so forth.

The conference server unit 312 is for monitoring connection states of a plurality of video conference devices 101, for executing connection control of the video conference devices 101, and for executing various processes of a video conference, such as communication of data (e.g., an image or an audio signal). The conference server unit 312 may be implemented by the communication I/F 805 and a program that is executed by the CPU 801, for example.

The encoding/decoding unit 902 may encode and decode an image of a conference that is relayed by the server device 102 by using a video encoding technique, such as H.264 SVC or H.264 AVC. The encoding/decoding unit 902 may be implemented by the codec 809 of FIG. 8, for example. As another example, the encoding/decoding unit 902 may be implemented by a program that is executed by the CPU 801 of FIG. 8.

The image processing unit (the correction unit) 903 is for applying, by using a rotation correction map (correction information) that is stored in the storage unit 313 in advance, a correction process (a rotation process) for correcting a rotational error to a conference image that is decoded by the encoding/decoding unit 902. The image processing unit 903 may retrieve, from map information 314 of the storage unit 313, a rotation correction map for an angle that corresponds to the request information that is received from the video conference device 101-1 by the conference server unit 312. Then, the image processing unit 903 may execute the rotation process for rotating the conference image by using the retrieved rotation correction map. Additionally, the image processing unit 903 may execute a cutting process for cutting the image, scaler processing (a resolution conversion process), and the like, so as to adjust the shift of the image that is caused by the rotation process. The image processing unit 903 may be implemented by the image processing unit 810 of FIG. 8 and a program that is executed by the CPU 801 of FIG. 8, for example.

The storage unit 313 is for storing map information. The map information may include a plurality of rotation correction maps. Each of the plurality of rotation correction maps corresponds to a rotational error or a tilt of a conference image. The storage unit 313 may be implemented by the storage unit 804 of FIG. 8, for example.

With the above-described configuration, the server device 102 may receive a conference image that is based on an image captured by the capture unit 301 of the video conference device 101-2, and the server device 102 may transmit the received conference image to the video conference device 101-1. Then, when the server device 102 receives the request information for requesting the rotation process of the conference image from the video conference device 101-1, the server device 102 may decode the conference image, apply the rotation process for rotating the conference image by a requested angle, and encode the image to which the rotation process is applied. Then, the server device 102 may transmit the encoded image to the video conference device 101-1.

<Processing Flow>

(Processing Flow at the Video Conference Device Side)

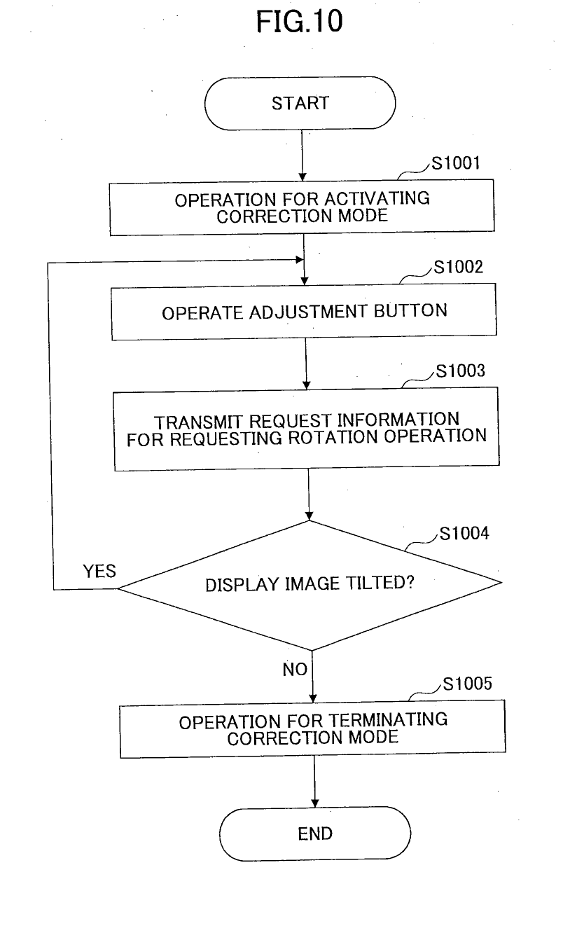

FIG. 10 is a flowchart showing a flow of a correction process of the video conference device according to the embodiment.

At step S1001, the video conference device 101 may receive an operation to activate the correction mode for correcting a rotational error or a tilt of a conference image that is displayed by the display unit 303 of the video conference image 101 through a predetermined operation (e.g., pressing of the determination button 606 of FIG. 6 for a long time period). After receiving the operation to activate the correction mode, the correction control unit 901 of the video conference device 101 may cause the display control unit 303 to display the grid lines 602 and the operation guide 603, such as shown in FIG. 6A.

At step S1002, the correction control unit 901 of the video conference device 101 may receive an adjustment operation by a user through an adjustment operation unit, such as shown in FIG. 6B.

At step S1003, in response to the adjustment operation by the user, the correction control unit 901 may transmit request information for requesting a rotation process for rotating the conference image to the server device 102. For example, in FIGS. 6A and 6B, when the left direction button 604 is pressed once in accordance with the operation guide 603, the correction control unit 901 may transmit request information for requesting rotation of the image by a predetermined angle (e.g., 1 degree) in the left direction to the server device 102. Similarly, when the right direction button 605 is pressed once, the correction control unit 901 may transmit request information for requesting rotation of the image by a predetermined angle (e.g., 1 degree) in the right direction to the server device 102. In the explanation below, the rotation in the right direction is indicated by “+,” and the rotation in the left direction is indicated by “−.” Namely, it is assumed that “rotation of +1 degree” indicates an operation for rotating the conference image by one degree in the right direction, and that “rotation of −2 degrees” indicates an operation for rotating the conference image by two degrees in the left direction.

At step S1004, a user may determine whether the display image that is displayed on the display unit 303 is tilted. When the user determines that the display image is tilted (YES in step S1004), the process returns to step S1002, and the adjustment button may be operated again. When the user determines that the display image is not tilted at step S1004 (No in step S1004), the user may perform an operation for completing the correction mode (e.g. long pressing of the determination button 606 of FIG. 6) (step S1005), and the user may terminate the correction mode.

(Processing Flow at the Server Device Side)

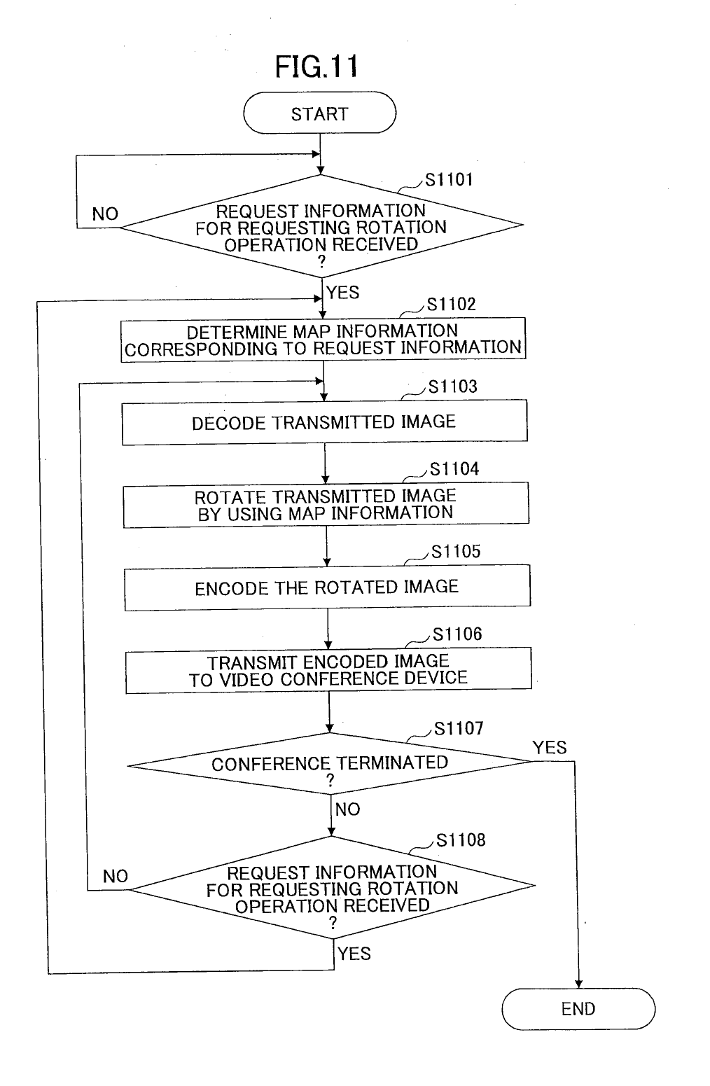

FIG. 11 is a flowchart showing a flow of the correction process of the server device according to the embodiment.

At step S1101, when the server device 102 receives the request information for requesting the rotation process from the video conference device 101, the process proceeds to step S1102.

After the process proceeds to step S1102, the image processing unit 903 of the server device 102 may determine the map information that is to be used for the correction process for correcting the conference image, based on the received request information. For example, when the received request information is request information for the first time, and the request information is for requesting the rotation process of +1 degree, the server device 102 may select the map information which is for the rotation angle of +1 degree. When the received request information is request information for the second time or after the second time, the server device 102 may select the map information to be utilized by adding a rotation angle that is included in the request information to the rotation angle of the current map information, for example.

At step S1103, the encoding/decoding unit 902 of the server device may decode the conference image (an image to be transmitted) that is to be transmitted to the video conference device 101 that transmits the request information.

At step S1104, the image processing unit 903 of the server device 102 may apply, by using the map information, a rotation process to the image to be transmitted that is decoded.

At step S1105, the encoding/decoding unit 902 of the server device 102 may encode the image to be transmitted to which the rotation process is applied.

At step S1106, the conference server unit 312 of the server device 102 may transmit the image to be transmitted, to which the rotation process and the encoding process are applied, to the video conference device 102 that is the source of the request information.

At step S1107, the server device 102 may determine whether the conference is terminated. When a determination is made that the conference is terminated (YES at step S1107), the process is terminated. When a determination is made, at step S1107, that the conference is not terminated (No at step S1107), the process proceeds to step S1108.

After the process proceeds to step S1108, the server device 102 may determine whether request information for requesting a rotation process is received from the video conference device 101. When a determination is made, at step S1108 (NO at step S1108), that the request information is not received, the process returns to step S1103, and the server device 102 may repeat the same process. When a determination is made, at step S1108, that the request information is received (YES at step S1108), the process returns to step S1102, and the server device 102 may determine map information corresponding to the received request information, and the server device 102 may execute the process of step S1103 and the process subsequent to step S1103.

According to the above-described process, when the server device 102 receives the request information from the video conference device 101, the server device 102 may repeat the decoding process, the rotation process, and the encoding process of the image to be transmitted using the map information corresponding to the request information, until the next map information is received or the conference is terminated. When the server device 102 receives the next map information, the server device 102 may update the map information to be used.

Next, by using a sequence chart, a specific example of the correction process is explained.

(Example of the Correction Process)

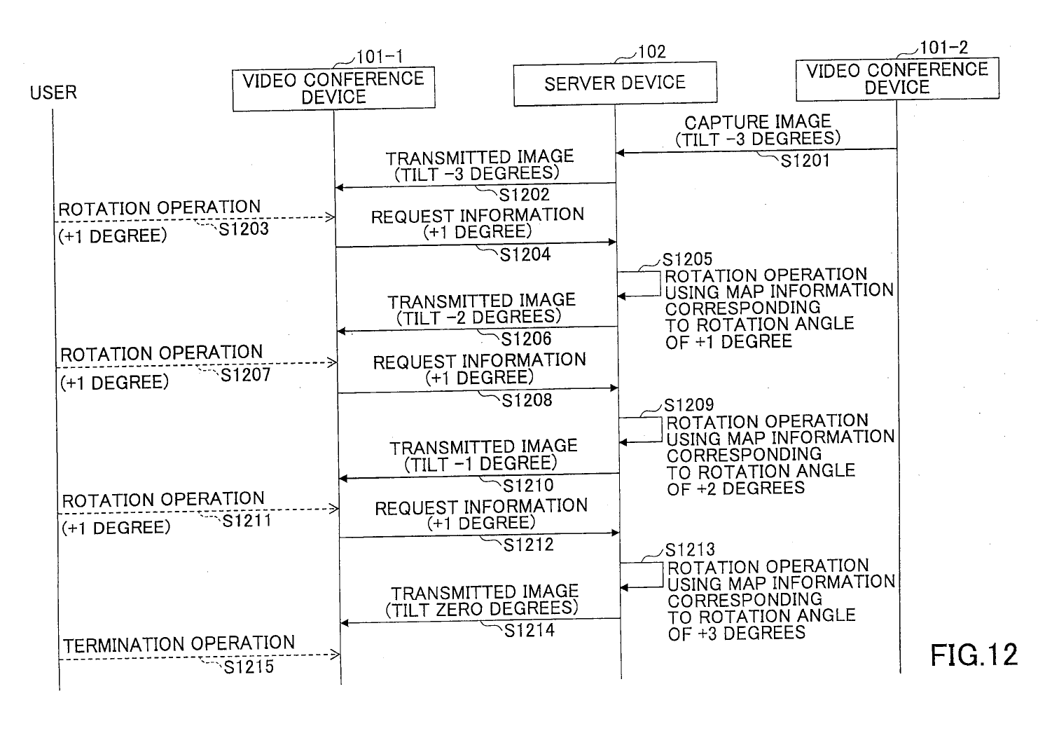

FIG. 12 is a sequence chart showing the example of the correction process according to the embodiment. Here, at the beginning in FIG. 12, it is assumed that the video conference device 101-1 and the video conference device 101-2 are communicating (during a video conference). In addition, it is assumed that the camera 205 of the video conference device 101-2 is tilted by −3 degrees, and that the image displayed on the display unit 210 of the video conference device 101-1 is also tilted by −3 degrees.

In general, in the video conference system 100, images of the conference are transmitted bidirectionally. However, for convenience of the explanation, only an image that is transmitted from the video conference device 101-2 to the video conference device 101-1 is explained. In addition, for simplicity of the explanation, it is assumed that the unit of adjustment of the conference image is one degree. However, this is for exemplifying purposes only. The unit of adjustment of the conference image may be another angle.

At step S1201, the video conference device 101-2 may transmit a conference image (captured image) that is captured by the capture unit 301 to the server device 102. The video conference device 101-2 may continuously transmit the captured image to the server device 102 until the end of the conference.

At step S1202, the server device 102 may transmit the image that is received from the video conference device 101-2 to the video conference device 101-1. At this time, the image that is displayed on the display unit 303 of the video conference device 101-1 is tilted by three degrees in the left direction. In the explanation below, the conference image that is to be transmitted from the server device 102 to the video conference device 101-1 is referred to as “transmitted image.”

At step S1203, a user may perform an operation for activating the correction mode. For example, by pressing the right direction button 605 of FIG. 6B once, the user may perform an operation for requesting a rotation process for rotating the transmitted image by +1 degree. In FIG. 12, the dashed allows indicate operations or the like by the user.

At step S1204, the video conference device 101-1 that receives the rotation operation that is input by the user may transmit request information for requesting the rotation operation for rotating the conference image by +1 degree to the server device 102.

At step S1205, the server device 102 that receives the request information for requesting the rotation operation of +1 degree may execute the rotation operation (which includes the decoding process and the encoding process) by using map information corresponding to the rotation angle of +1 degree. By doing this, the tilt of the captured image that is −3 degrees can be corrected to be −2 degrees.

At step S1206, the server device 102 may transmit the transmitted image that is tilted by −2 degrees to the video conference device 101-1. At this time, the image displayed on the display unit 303 of the video conference device is tilted by two degrees in the left direction.

At step S1207, by pressing, by the user, the right direction button 605 once, an additional +1 degree rotation operation may be applied to the conference image.

At step S1208, the video conference device 101-1 that receives the input of the user for the rotation operation may transmit request information for requesting the rotation operation for rotating the conference image by +1 degree to the server device 102.

At step S1209, the server device 102 that receives the request information for requesting the +1 degree rotation operation may execute the rotation operation by using the map information corresponding to the angle that is obtained by adding +1 degree to the rotation angle of the currently used map information (that is +1 degree), namely, by using the map information corresponding to the rotation angle of +2 degrees. By doing this, the tilt of the captured image that is −2 degrees can be corrected to be −1 degree.

At step S1210, the server device 102 may transmit the transmitted image that is tilted by −1 degree to the video conference device 101-1. At this time, the image that is displayed on the display unit 303 of the video conference device 101-1 is tilted by one degree in the left direction.

At step S1208, by pressing, by the user, the right direction button 605 once, an additional +1 degree rotation operation may be applied to the conference image.

At step S1212, the video conference device 101-1 that receives the input of the user for the rotation operation may transmit request information for requesting the rotation operation for rotating the conference image by +1 degree to the server device 102.

At step S1213, the server device 102 that receives the request information for requesting the +1 degree rotation operation may execute the rotation operation by using the map information corresponding to the angle that is obtained by adding +1 degree to the rotation angle of the currently used map information (that is +2 degrees), namely, by using the map information corresponding to the rotation angle of +3 degrees. By doing this, the tilt of the captured image that is −1 degree can be corrected to be zero degrees.

At step S1214, the server device 102 may transmit the transmitted image that is tilted by zero degrees to the video conference device 101-1. At this time, the image that is displayed on the display unit 303 of the video conference device 101-1 is tilted by zero degree, namely the image is not tilted. At step S1215, the user may perform an operation for terminating the correction mode.

By the above-described process, the tilt of the conference image that is displayed on the video conference image 101-1 can be corrected. The server device 102 may continuously execute the rotation process for rotating the transmitted image by using the map information corresponding to the rotation angle of +3 degrees, until the next request information is received from the video conference device 101-1.

As described above, the image processing unit (the correction unit) for correcting the rotational error of the conference image may be included in the server device 102.

Consequently, the video conference system 100 may easily correct a rotational error or a tilt of an image that is captured by the capture unit 301 at any site, even for the video conference device 101 that does not include an image processing unit for correcting a rotational error of a conference image.

In addition, since it is not required that the video conference device 101 includes an image processing unit (a correction unit) for correcting a rotational error of a tilt of a conference image and a storage area for storing the correction information, the cost of the video conference device 101 can be reduced.

Furthermore, since the video conference device 101 does not download the map information 314, the communication bandwidth between the video conference devices 101 can be effectively utilized, especially for a case in which the communication bandwidth is narrow.

A communication device (101) according to the embodiment includes a display unit (303) for displaying a display image based on an image that is captured by a capture unit (301). Further, the communication device (101) includes a retrieval unit (305) for selectively retrieving one correction information item from a server device (102) that stores a plurality of correction information items (314) corresponding to rotational errors or tilts of the capture unit (301). Furthermore, the communication device (101) includes a correction unit (302) for correcting the display image based on the correction information item (314) that is retrieved by the retrieval unit (305).

With the above-described configuration, the communication device (101) may easily correct the rotational error or the tilt of the image that is captured by the capture unit (301) (e.g., the camera 205) that is disposed at any site. In addition, the communication device (101) can correct a rotational error or a tilt of an image that is caused by the capture unit (301) without enlarging the memory capacity for storing the plurality of correction information items corresponding to the rotational errors of the tilts of the capture unit (301).

A communication system (100) according to the embodiment of the present invention includes a capture unit (301) for capturing an image and a display unit (303) for displaying a display image based on the captured image. In addition, the communication system (100) includes a storage unit (313) that stores, in advance, a plurality of correction information items (314) corresponding to rotational errors or titles of the capture unit (301), and a correction unit (903) for correcting the display image based one of the plurality of the correction information items (314) that is stored.

With the above-described configuration, the communication system (100) can easily correct a rotational error or a tilt of an image that is captured by the capture unit (301) at any site.

Here, the reference numerals within the parentheses are for facilitating understanding of the embodiments. These are for exemplifying purpose only, and it is not intended to limit the scope of the present invention.

The present invention is not limited to the specifically disclosed embodiments, and variations and modifications may be made without departing from the scope of the present invention.

The present application is based on and claims the benefit of priority of Japanese Priority Applications No. 2014-052942, filed on Mar. 17, 2014, and No. 2014-263885, filed on Dec. 26, 2014, the entire contents of which are hereby incorporated herein by reference.

What is claimed is:

1. A communication device comprising:
a display unit configured to display a display image based on an image that is captured by a capture unit;
a retrieval unit configured to selectively retrieve one correction information item from an information processing device that stores, in advance, a plurality of the correction information items corresponding to rotational errors or tilts of the capture unit; and
a correction unit configured to correct the display image based on the retrieved correction information item.

2. The communication device according to claim 1,
wherein the captured image is captured by a capture unit that is included inside or connected to a communication destination device that is a communication destination of the communication device.

3. The communication device according to claim 2,
wherein the communication device is configured to communicate with the communication destination device through the information processing device.

4. The communication device according to claim 1, further comprising:
a transmitter configured to transmit the captured image,
wherein the correction unit is configured to correct the image that is to be transmitted based on the retrieved correction information item.

5. The communication device according to claim 1,
wherein the retrieval unit is configured to retrieve the one correction information item based on angular information of a rotational error or a tilt of the display image.

6. The communication device according to claim 5, further comprising:
a notification unit configured to report the angular information to a communication destination device that is a communication destination of the communication device.

7. The communication device according to claim 1,
wherein the retrieval unit is configured to retrieve the one correction information item based on angular information that is reported from a communication destination device that is a communication destination of the communication device.

8. The communication device according to claim 1,
wherein the plurality of correction information items are data corresponding to a plurality of correction angles and resolutions.

9. The communication device according to claim 1, further comprising:
a non-volatile storage unit configured to store the correction information item that is retrieved from the information processing device.

10. A communication system comprising:
a capture unit configured to capture an image;
a display unit configured to display a display image based on the captured image;
a storage unit configured to store, in advance, a plurality of correction information items corresponding to rotational errors or tilts of the capture unit; and
a correction unit configured to correct the display image based on the plurality of correction information items that are stored.
